(19) United States
(12) Patent Application Publication
(10) Pub. No.: US 2008/0123353 A1
(43) Pub. Date: May 29, 2008

(54) Food emulator with an acoustic-optic effect for congratulating

(76) Inventor: Fong-Ku Liu, Yonghe City (TW)

Correspondence Address: Troxell Law Office Pllc, Suite 1404, 5205 Leesburg Pike, Falls Church, VA, 22041, US

(21) Appl. No.: 11/605,430

(22) Filed: Nov. 29, 2006

(51) Int. Cl. F21V 3/02

(52) U.S. Cl. 362/375; 362/565

(57) ABSTRACT

A food emulator used for congratulating, more particularly to a decoration emulator which is provided with an acoustic-optic effect to generate a shiny decoration and to play congratulation songs, is primarily composed of a housing of a food decoration, wherein a surface of the housing is provided with a patterned optical block, and an interior of the housing is provided with an illuminating device and a voice device. Through a control by a working circuit, the acoustic-optic effect can be generated to be scattered out from the emulator, thereby acting as congratulation and a presentation, as well as a decoration and a daily appliance in a normal condition.

### BACKGROUND OF THE INVENTION

(a) Field of the Invention

The present invention relates to a food emulator with an acoustic-optic effect for congratulating, and more particularly to a food emulator which is used for congratulating and is provided with an acoustic-optic manifestation and a practical function in a daily life.

(b) Description of the Prior Art

It is known that in order to show regards to a respectful person, gifts of congratulation are often presented on his or her birthday. The common gifts include birthday cakes or birthday peaches. The birthday peaches include emulated pastries made by flour, which are also used in a temple ritual. However, for the existing pastries used for congratulating, true products are ordinarily used for presentation. As their freshness is affected by time of settling, fermentation or contamination by germs will be resulted if they are settled too long, thereby causing a waste. In addition, after the gifts of congratulation have been eaten, they no longer exist; on the other hand, they are easily deformed to affect their beauty by an influence of external force during transportation.

### SUMMARY OF THE INVENTION

Accordingly, the present invention provides in particular an emulator, with its appearance imitating a pastry, such as a birthday peach or a birthday cake, for congratulating, and its main body generating a shiny decoration and an acoustic-optic effect, which can achieve a same presentation of regards as congratulating and saluting and provide another kind of practical function in a daily life.

The primary object of present invention is to provide a housing for emulating a food decoration used for congratulating, with its surface being provided with a pattern and an optical reaction block, and its interior being provided with an illuminating device and a voice device. The acoustic-optic devices can manifest the acoustic-optic effect in congratulation to make a mood of environment through a control of a working circuit, and after congratulation, the present invention can be used as a decoration. In addition to creating congratulation music or birthday songs, the voice device is further provided with a voice input microphone to constitute a message recorder or a diary logger for recording words of mood. The illuminating device can be used as a little night lamp for providing a nighttime warning. Therefore, the entire present invention manifests an effect of magnificent shining and practicability.

A second object of the present invention is to provide a food decoration with an acoustic-optic effect for congratulating, wherein the housing is formed with a plastic extrusion or is formed by surrounding with cloth that is sewn.

A third object of the present invention is to provide a food decoration with an acoustic-optic effect for congratulating, wherein a wavelength of the illuminating device is changeable, for example, by regulating with an LED (Light-Emitting Diode) through the working circuit, so as to form a mixed color or to change into an optical flow of different wavelength.

A fourth object of the present invention is to provide a food decoration with an acoustic-optic effect for congratulating, wherein fiber-optical bundles are introduced into a path of light transmission of a related housing of the illuminating device, so as to form a directional light transmission or to weave into a shaped decoration by the fiber-optical bundles.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a side view of an embodiment of the present invention.

FIG. 3 shows a schematic view of related devices assembled in an interior of the present invention.

FIG. 4 shows a schematic view of a backlit device in an interior of an embodiment of the present invention.

FIG. 5 shows a schematic view of a backlit device in an interior of another embodiment of the present invention.

FIG. 6 shows a schematic view of an optical block formed by spun of optical fibers of the present invention.

FIG. 7 shows a schematic view of an embodiment of an image monitoring device of the present invention.

### DETAILED DESCRIPTION OF THE PREFERRED EMBODIMENTS

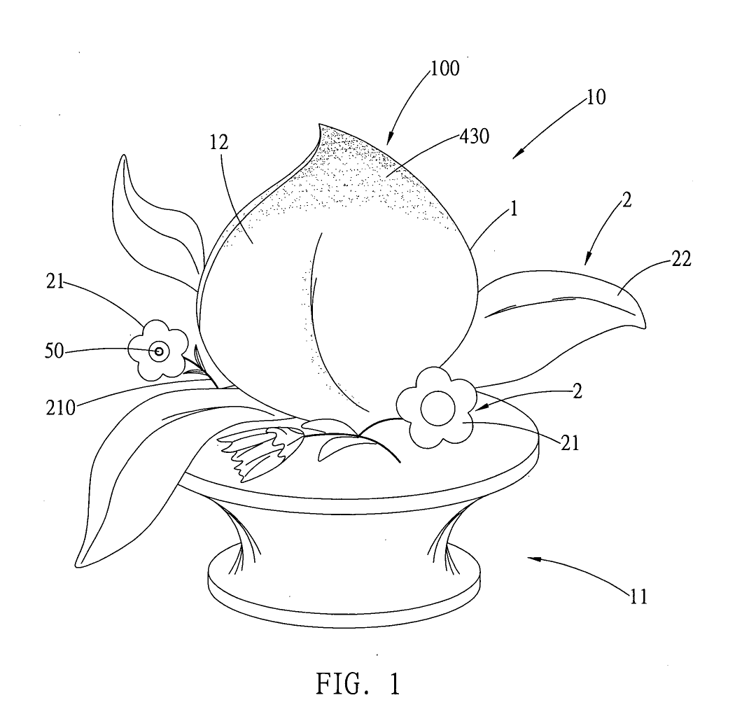

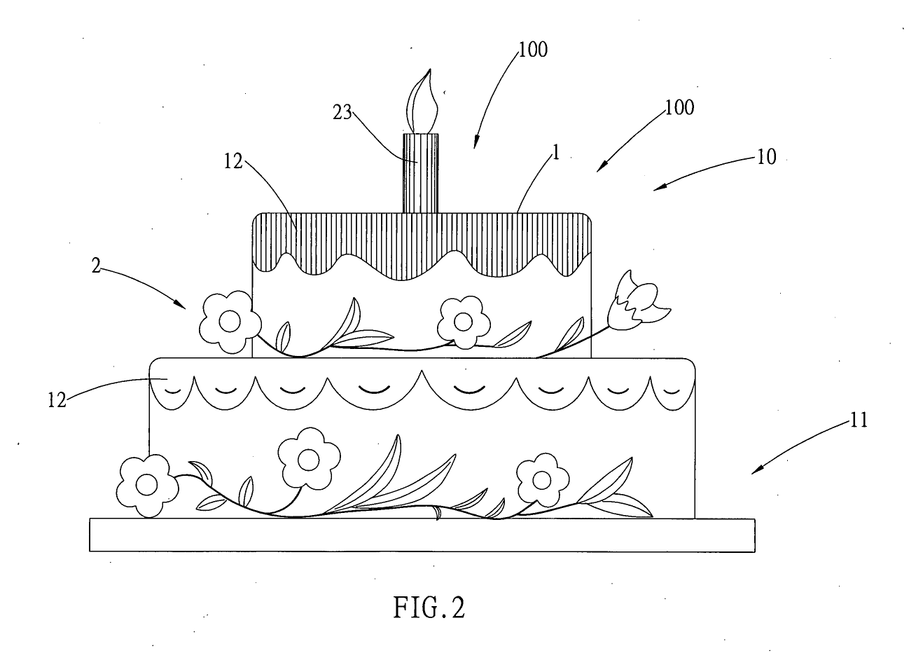

Referring to FIG. 1 and FIG. 2, an emulator 10 of the present invention comprises primarily a decoration imitator 100 for emulating an appearance of food, such as a birthday peach or a birthday cake, with its periphery being distributed with shaped decorations 2 including flowers 21, leaves 22, or a candle 23. The food decoration 100 includes a housing 1 which is defined into an optical block 12 according to a specification of pattern, and the optical block 12 can transmit light through an interior light source.

The housing 1 can be any plastic product formed by a plastic extrusion, or can be made by surrounding with any knitting material such as a ribbon, if it is made by molding plastic material. Similarly, the shaped decorations 2 can be also formed by the aforementioned methods to be assembled at the periphery of food decoration 100.

In addition to three-dimensional objects, the shaped decorations 2 can be painted with colors, printed, or pasted with planar decorations to form leaf pieces.

The food decoration 100 is constituted by the housing 1 which is transparent or semi-transparent. In order to form different luminousness or to change chroma on its surface, the surface corresponding to the optical block 12 can be painted according to a pattern, such as if a tip of the birthday peach can be sprayed with a red paint, then a haloing red wave can be refracted.

A bottom of the food decoration 100 can be supported by a base 11 which can be assembled with the food decoration 100 into a one-body emulator 10.

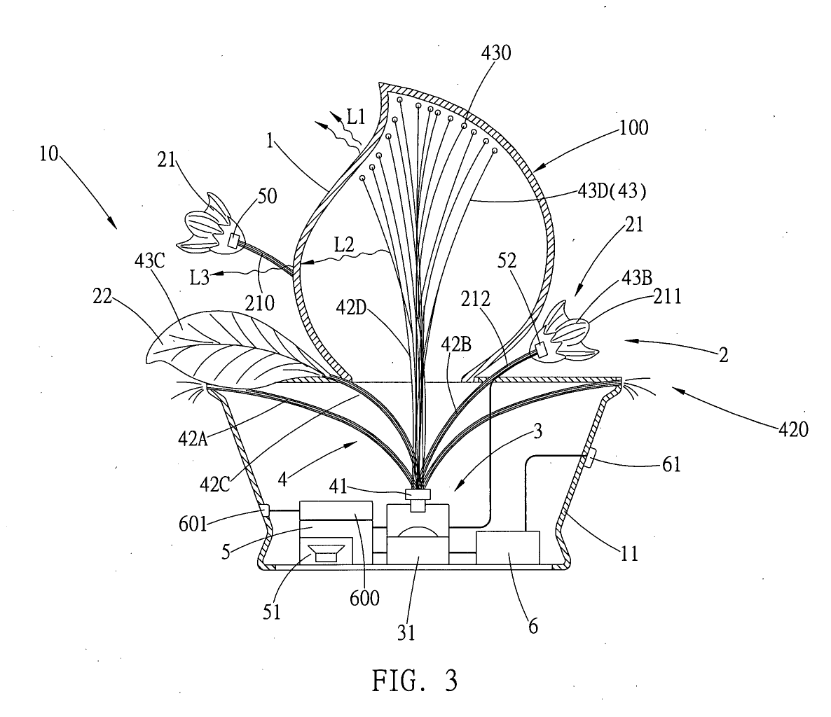

Referring to FIG. 3, a method of distributing related acoustic-optic devices of the present invention is described with an embodiment of the birthday peach emulator 10 for congratulating. A food decoration 100 in a shape of a birthday peach is formed by a housing 1, an interior of which is a free space for connecting to an interior of the base 11, and is provided with an illuminating device 3, a voice device 5, and a working circuit 6. The working circuit 6 is controlled by a switch 61 to select an operation instruction, the voice device 5 is provided with an audio emulator 51 to play audio signals, and is connected to an exterior microphone 52 which provides for a user to record. The audio signal information recorded is stored by a memory device, so as to form a message recording device or a diary logger for recording vocal messages.

The voice device 5 can be operated in an analog or digital mode. If it is working in the digital mode, then it will be assembled by electronic components such as a programmable integrated circuit, a memory device, a computation unit, or an I/O port. The operation mode can be controlled and selected through an option switch. As the layout of integrated circuit and computation unit, et al., belongs to an ordinary programmable circuit, it will not be described further.

The microphone 52 can be installed at a proper position of the base 11 or can be hidden in an interior of the shaped decoration 2, to prevent from affecting the appearance and to facilitate a user to operate from top.

The illuminating device 3 includes primarily a set of light source 31 which is an ordinary incandescent lamp or an LED (Light-Emitting Diode). If the LED is implemented, then a lamp assembly of three primary colors of red, green, and blue, can be used. The wavelength is regulated by the working circuit 6, and different optical waves are generated among the red, green, and blue, respectively, to result in an interference of mixed colors, so as to change into an optical flow of different chroma, which can be directly projected on the transparent housing 1 or can be formed into a directional light transmission using a path distributed by an optical fiber itself, through an introduction of a fiber-optical bundle 4 into the transmission path.

The fiber-optical bundle 4 can be formed into a branch bundle 42A, with its projection end acting on any desired position respectively, such as at an upper edge of the base 11 for generating light petals 420 toward an exterior side, or into a branch bundle 42B which can be formed into a scape 212 of a flower 21 of the shaped decoration 2, and which is assembled by a plurality of spun of optical fibers 43B. A tail end of the spun of optical fiber 43B (the projection end) can be weaved into a petal 211 with its wiring material. Similarly, a leaf 22 can be weaved from a spun of optical fiber 43C which is distributed from a branch bundle 42C. Correspondingly, for the food decoration 100, by using a corresponding branch bundle 42D, positions that an optical flow should be accumulated in the housing 1 can be distributed, wherein a tail end of a spun of optical fiber 43D positioned in the interior of housing 1 can be fixed on an interior surface of the housing 1 with any method, and a light spot 430 that arises will be refracted out to form a refraction light L1 through the housing 1. The light spot 430 is emitted from a surface of projection end of the spun of optical fiber 43D which is made by a material with a certain degree of loss. Therefore, a radial loss light L2 will be formed at a side of each spun of optical fiber 43D. Similarly, the radial light L2 will transfix the housing 1 to form into another kind of refraction light L3. The aforementioned refraction light L1 is stronger than L3, and a contrast effect of brightness is formed by a different lumen between L1 and L3, thereby enabling a surface of the food decoration 100 to form a distribution of chroma.

A wavelength of optical flow carried by the spun of optical fiber 43 is determined by the set of light source 31. If the food decoration 100 requires transmitting a red light, then the set of light source 31 can generate the desired optical waves to provide the refraction light for decorating.

Basically, the set of light source 31 is one set. However, if different chroma should be generated between the food decoration 100 and shaped decoration 2, then the set of light source 31 can be configured as more than two sets, correspondingly, to distinguish different optical waves, so as to differentiate the food decoration 100 and the shaped decoration 2. Even when the related petal 21 or green leaf 22 requires different chroma, a plurality of sets of light source 31 can be used to project the light correspondingly.

The set of light source 31 is used to change colors. In addition to using the LED to regulate the wavelength through the working circuit 6, a raster of a conventional circular palette can be used, which corresponds to a lamp after driven by a motor, so as to filter out different wavelengths. A coupler 41 which operates on the fiber-optical bundles enables each spun of optical fiber 43 to acquire the wavelength of optical flow after being changed, thereby projecting into the optical flow of different chroma. The conventional palette is a circular raster, with its breadth being divided into a plurality of filtering-refraction surfaces of different wavelengths (color lumps).

If the aforementioned illuminating device 3 is used as a little night lamp, then the wavelength can be configured as that of a single and fixed chroma, to prevent from affecting a sense of vision.

The voice device 5 can generate sound wave and a size of its volume is determined by an electric current. Therefore, after taking a sample of the electric current generated by the voice device 5, the electric current can be used between the voice device 5 and the illuminating device 3 to activate an instruction for driving the illuminating device 3, thereby manifesting a light decoration of an acoustic-optic action.

Referring to FIG. 1 and FIG. 3, a proper position of the shaped decoration 2, such as the flower 21, installed on the emulator 10 can be deployed with a video camera lens 50 for retrieving images of surrounding environment and allowing an output port 601 to export the image data at any time after a recording device 600 stores the data. By bending and turning a deformable flower scape 210, a shooting angle of the lens 50 can be changed. Therefore, the emulator is a fixed device, and by the deformability of the flower scape 210, the shooting orientation of the lens 50 can be adjusted. Whereas, the image signal retrieved by the lens 50 is transmitted to the recording device 600 for information storage and outputting through the output port 601. Similarly, the output port 601 can form a network link and provide a remote monitoring, and the network link is linked to an information network through a data acquisition card and a processing device.

Accordingly, in addition to manifesting a meaning of congratulation and salutation, the present invention can even serve as a little night lamp for a nighttime warning, a decoration, a voice recorder, or an image recorder in a normal condition, and can be further used as a remote monitoring, thereby achieving a versatile requirement of usage in a daily life.

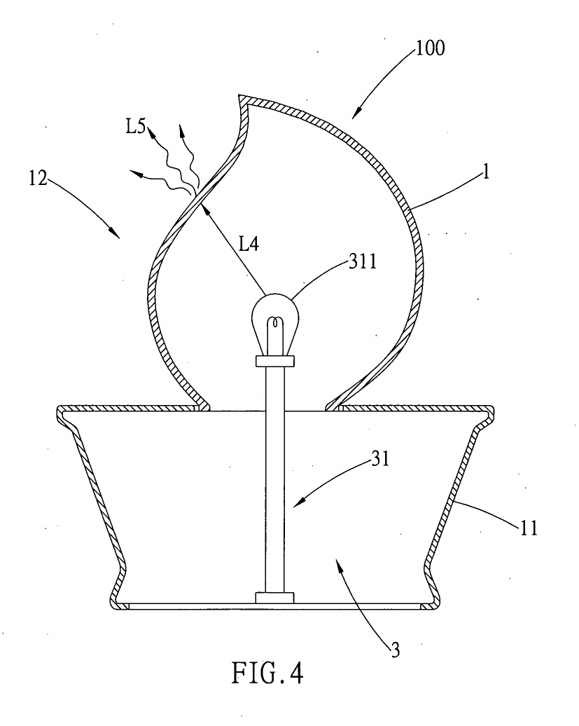

Referring to FIG. 4, the illuminating device 3 is a backlit lamp 311 and an optical flow L4 generated by the backlit lamp 311 directly operates on an optical block 12 to refract out a refraction light L5, thereby forming a backlit function.

As shown in FIG. 4, if the housing 1 uses only one backlit lamp 311, then for a change of chroma on its surface, the surface of housing 1 can be sprayed by other pigment which is able to transmit the light, such that the food decoration 100 can generate a pattern of different chroma.

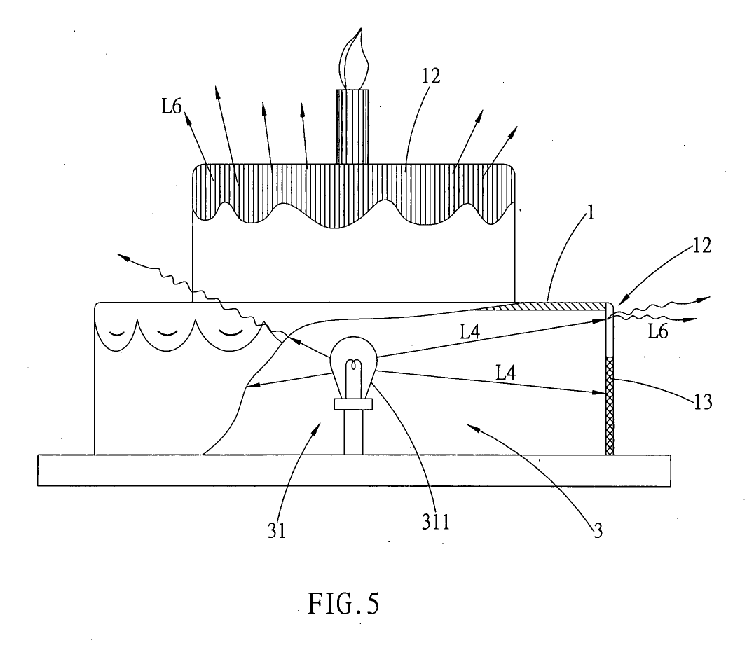

Referring to FIG. 5, the optical flow L4 generated by the backlit lamp 311 operates on an interior surface of the housing 1. If the related optical block 12 is provided with a higher luminousness, then a refraction light L6 of higher intensity can be refracted out. If some part of the housing 1 is formed into a cut-off surface 13, then the optical flow L4 will be cut off and cannot be transmitted out.

Upper and lower layers of a cake shape decoration can be provided with the optical blocks 12, and thus rays of light generated by the backlit lamp 311 can be refracted out to form the refraction light from the optical blocks 12.

The luminousness of aforementioned optical block is larger than that of the housing 1, and the housing 1 can be configured as being completely impervious to light or half pervious to light. Similarly, the backlit lamp 311 can also change the optical waves using the same method for regulating the wavelength as described above.

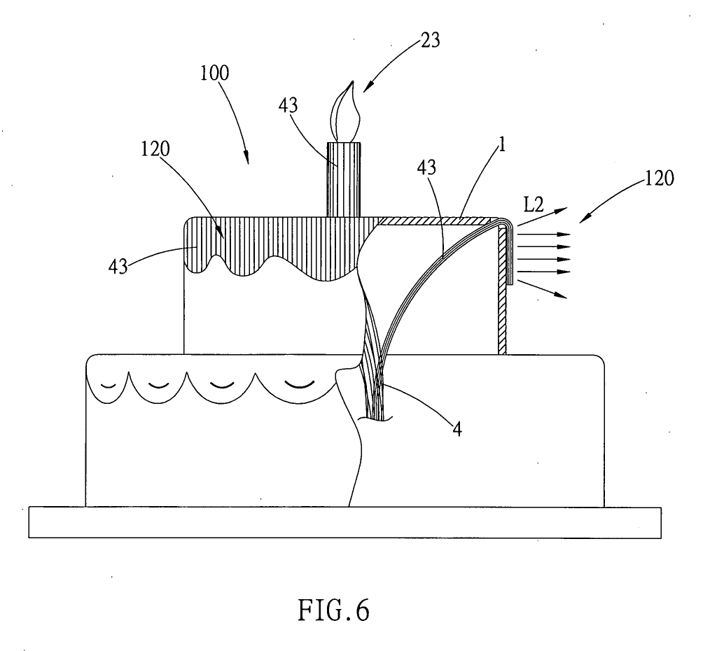

In addition to forming the optical blocks 12 by the housing 1, as described above, the optical blocks 12 can be even exposed on an exterior surface of the housing 1 (as shown in FIG. 6) by transfixing the projection ends of spun of optical fibers 43 of fiber-optical bundles 4 out of the housing 1, and are assembled into an optical block 120 in a parallel manner. By using the radial loss light L2 of spun of optical fiber 43, the optical block 120 can generate the rays of light. Similarly, a candle 23 can also be assembled and emulated by parallel surrounding a plurality of spun of optical fibers, and the rays of light can be escaped from the radial loss lights of the plurality of spun of optical fibers 43.

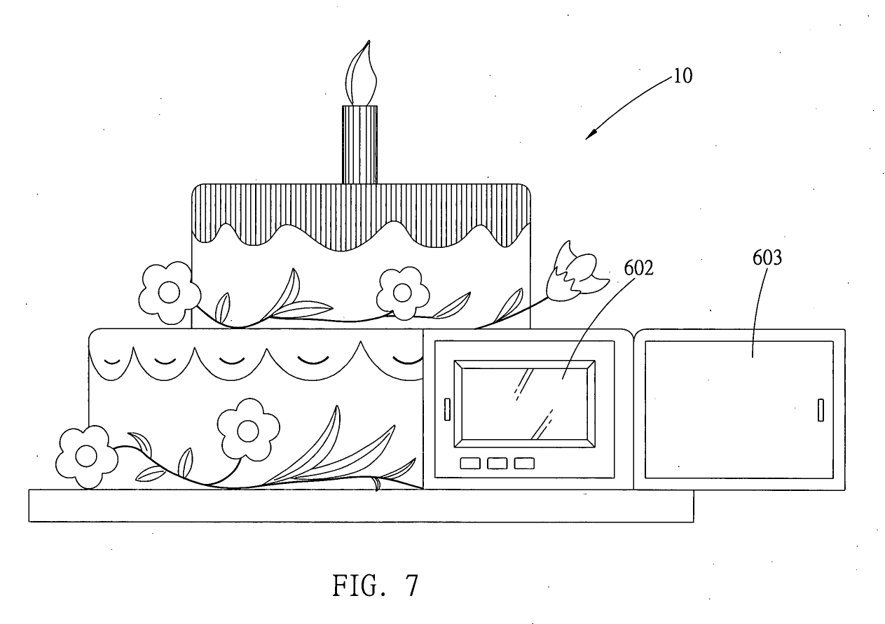

Referring to FIG. 7, a related image simulation of the present invention includes a monitor 602 which is installed on a same body of the emulator 10. The monitor 602 is able to acquire the image signal from the recording device 600 to display the stored image frames, wherein the monitor 602 can be a thin liquid crystal panel which is installed in an interior of a door 603 with an appearance being formed in accordance with an appearance of the emulator 10.

The present invention is primarily to provide a food emulator used for congratulating, which can manifest a magnificent chroma and play congratulation songs during a ritual, thus forming another kind of congratulation gifts, serving as a message recorder or a diary logger for recording words of mood in a normal condition, or serving as a little night lamp to form into a nighttime indication and warning.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A food emulator with an acoustic-optic effect for congratulating, comprising a housing of a semi-transparent food decoration, a surface of which is provided with an optical block according to a pattern, and an interior of which is provided with a set of illuminating device which transfers an optical flow through an optical path to the food decoration and optical block or shaped decorations, a voice device which includes a microphone and an audio memory device, and a working voltage which operates the aforementioned illuminating and voice devices.

2. The food emulator with an acoustic-optic effect for congratulating, according to claim 1, wherein the housing is made by molding plastic material.

3. The food emulator with an acoustic-optic effect for congratulating, according to claim 1, wherein the housing is formed by a plastic extrusion.

4. The food emulator with an acoustic-optic effect for congratulating, according to claim 1, wherein the housing is made by surrounding with a knitted cloth.

5. The food emulator with an acoustic-optic effect for congratulating, according to claim 1, wherein an exterior surface of the housing is distributed with shaped decorations.

6. The food emulator with an acoustic-optic effect for congratulating, according to claim 5, wherein the shaped decorations are formed by molding.

7. The food emulator with an acoustic-optic effect for congratulating, according to claim 5, wherein the shaped decorations are formed by knitting with a ribbon.

8. The food emulator with an acoustic-optic effect for congratulating, according to claim 1, wherein a wavelength of the illuminating device is changeable.

9. The food emulator with an acoustic-optic effect for congratulating, according to claim 8, wherein a light source of the illuminating device is an LED (Light-Emitting Diode), with its wavelength being regulated through the working circuit.

10. The food emulator with an acoustic-optic effect for congratulating, according to claim 9, wherein the LED is made by a light emitter of three primary colors of red, blue, and green.

11. The food emulator with an acoustic-optic effect for congratulating, according to claim 8, wherein the illuminating device is an incandescent lamp which filters out different chroma through a raster of a palette.

12. The food emulator with an acoustic-optic effect for congratulating, according to claim 1, wherein the illuminating device transmits light to the optical block directionally, by introducing a fiber-optical bundle.

13. The food emulator with an acoustic-optic effect for congratulating, according to claim 12, wherein a projection end of the spun of optical fiber transfixes out of an exterior surface of the housing, and an optical block is formed by exposing a plurality of the projection ends parallel.

14. The food emulator with an acoustic-optic effect for congratulating, according to claim 12, wherein a tail end of the spun of optical fiber is accumulated into the shaped decoration.

15. The food emulator with an acoustic-optic effect for congratulating, according to claim 1, wherein the illuminating device is a backlit lamp which is positioned in an interior of the housing.

16. The food emulator with an acoustic-optic effect for congratulating, according to claim 1, wherein the voice device is provided with an I/O port.

17. The food emulator with an acoustic-optic effect for congratulating, according to claim 1, wherein the voice device operates in an analog or digital mode.

18. The food emulator with an acoustic-optic effect for congratulating, according to claim 1, wherein an audio signal of the voice device activates the illuminating device to form an instruction for illuminating.

19. The food emulator with an acoustic-optic effect for congratulating, according to claim 1, wherein a camera lens is installed at a position of the shaped decoration, facing toward an exterior side; image information being stored by an internal recording device and transmitted outward from an output port.

20. The food emulator with an acoustic-optic effect for congratulating, according to claim 19, wherein the shaped decoration is a flower and is provided with a deformable scape for adjusting a shooting angle of the lens.
